(19) United States
(12) Patent Application Publication
(10) Pub. No.: US 2019/0122190 A1
(43) Pub. Date: Apr. 25, 2019

(54) DISBURSEMENT AND SETTLEMENTS SYSTEM AND METHOD

(71) Applicant: Robert Conyers, Montreal (CA)

(72) Inventor: Robert Conyers, Montreal (CA)

(21) Appl. No.: 16/224,569

(22) Filed: Dec. 18, 2018

Related U.S. Application Data
(63) Continuation of application No. 15/437,992, filed on Feb. 21, 2017, now abandoned.
Application No. 15/437,992 is a continuation-in-part of application No. 14/158,934, filed on Jan. 20, 2014, now abandoned.
(60) Provisional application No. 61/754,751, filed on Jan. 21, 2013.

(51) Int. Cl. G06Q 20/10; G06Q 20/34; G06Q 20/40; G06Q 20/32

(52) U.S. Cl. CPC G06Q 20/108; G06Q 20/34; G06Q 20/405; G06Q 20/3223; G06Q 20/4012

(57) ABSTRACT

A computer implemented method and a system for transferring funds between a payor and a payee using a single mobile phone. The method is implemented on a payment processing system and uses transaction information including a payor debit card number, a payor PIN, a payee debit card number and an amount of money to transfer the funds from a payor demand deposit account (DDA) to a payee DDA without using a notify and pay instrument. The payor and the payee interact with the payment processing system with a single mobile phone.

### FIELD OF THE INVENTION

The above-mentioned invention relates to payment and settlement systems, and more particularly to an on-line electronic money transfer system and methodology.

### BACKGROUND

Numerous disbursement and settlement schemes facilitating transactions between payers and payees are well known in the art. These schemes provide the mechanisms we generally use to effect financial transactions with one another. Some of these schemes are long-established, for example cash, cheques, money orders or drafts, and some schemes are state-of-the-art automated systems, for example those that may process recurring payments or recurring direct deposits between payors and payees.

Normally, one or more of these schemes could be used by any one person or entity to transact with any other person or entity. Typically, transactions depend on a mechanism commonly known in the art as a demand deposit account (DDA). A DDA is typically a transaction account, for example a chequing account or a savings account held at service providers such as a banks and financial institutions which may be deposited to or withdrawn from by the customer generally at any time.

Typically, the schemes that could be used by any one person or entity to transact with any other person or entity are separated as a customer might enter into agreements with one or more service providers, and, might enter into one or more agreements with each service provider regarding specific payments and settlements to be made out of money available in an account. For example a customer may enter into one or more agreements with their service provider (e.g. a bank) to authorize making pre-planned or recurring payments from his account, and then enter into one or more separate agreements with that service provider or with an entirely different service provider to make ad hoc (e.g. unplanned or non-recurring) payments and settlements from that same account or from an other account which the customer may elect to have or which may be may be required for those purposes by the service provider.

Normally, each agreement requires specific protocols for its operation. For example, a customer maintaining an account and associated pre-planned payments authorizations in the same service provider is nevertheless obliged to enter into separate agreements to make ad hoc payments or to make payments to non-recurring or unplanned payees, or to make payments to new recurring or planned payees.

A typical consequence of an individual entering into and operating these agreements is the furnishing and transmission of confidential information. By way of example, a customer entering into an agreement to operate a demand deposit account with a service provider, e.g. a bank, is normally supplied a Card, such as a Debit Card, which the customer may then use to transact, for example, with merchants on-line. Such transactions typically may require a customer to enter into agreements with each of these entities or with service providers associated with these entities, or may require a customer to enter into agreements with one or more entities or intermediaries through which e-commerce transactions may be made with these entities. Typically, to use these various electronic payments schemes, a customer entering into these agreements to make payments, a payor, is required to divulge some form of personally identifiable information. There is currently no manner for an individual to enter into such agreements in an online environment without giving away some form of personally identifiable information. The more information the customer transmits over the Internet, the greater the likelihood that his confidentiality will be breached.

As increasing numbers of customers become connected to the Internet, the number of electronic payments increases proportionately, as does the risk of breaching confidential information.

Typically, customers have multiple transaction needs and experience a wide range of circumstances and contexts in which they may effect their day-to-day transactions. As more and more customers become connected to the Internet, they typically adopt a range of mechanisms to meet their transaction needs. The more agreements the customer may enter into the greater the divulgation of personal identifiable information and the greater the likelihood that such information will be compromised.

Additionally, it is often difficult for persons or entities to effect money transfers without having to use a ‘paper’ method such as a cheque, money order, draft or cash; card transactions are not widely available for individuals.

Typically, individuals or entities have multiple transaction needs and experience a wide range of circumstances and contexts in which they may effect their ordinary day-to-day transactions. Typically, the majority of these transactions are between individuals and small business people and are spontaneous, unplanned and involve relatively small amounts of money. As illustrated below, deciding the means of payment may frequently involve mitigating financial and personal inconveniences.

By way of an illustrative scenario and commentary, a single working parent, returning home after her night school, needs to pay the baby sitter. She discovers herself short of cash and must turn to ‘solution-finding’ to pay the amount she owes the sitter. She can, for example: despite the obvious inconvenience to the sitter, empty the change out her kids' piggy banks (and then have to remember to top them back up again soon), make an unplanned round trip to the ATM to withdraw the cash she needs, or incur an IOU (necessitating a post-it note on the fridge reminding her to block off time to drive the cash over to the sitter's home in the next day or two, or asking the sitter to come back to collect her money). She could, assuming she's a subscriber herself to such a service, offer to pay the baby sitter using an on-line ‘notify and pay’ type service such as PayPal or Interac Etransfer, only to learn that the baby sitter would have difficulty negotiating the notify and pay instrument at the teller because she's ordinarily in school or at her part-time job during bank opening hours. The parent could also, assuming she has an account with chequing privileges, offer to write the sitter a cheque. While this choice may address the inconvenience with the ‘notify and pay’ option as the sitter could deposit the cheque at the ATM, the sitter has learned that a ‘hold’ on the funds would be applied and she could not have access to her money until the hold period lapses several days after deposit. In the context of other possible options, using her debit card or credit card to pay the baby sitter is futile as neither she nor the baby sitter is an authorized card accepter.

Accordingly, there is a need in the industry for systems and methods for transferring funds electronically that are less complex than existing methods. There exists also a need in the industry to for systems and methods for transferring funds electronically between individuals spontaneously without requiring that the payee is registered to the same service as the payor.

### SUMMARY OF THE INVENTION

Advantageously, the proposed invention offers a comprehensive, spontaneous payment system and method facilitating face-to-face direct transacting between persons or entities at any time and from anywhere when a mobile phone can communicate with a network to which the payee and payor financial institutions are connected.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the following description, reference is made to drawings accompanying and forming part of this application and of the invention and its various embodiments, and by which is shown various ways in which the invention may be deployed. It is to be understood that other embodiments that exist presently as well as new ones may be incorporated and structural and functional modifications to them may be made.

FIG. 1, in a schematic block diagram, illustrates a system for performing a fund transfer method in accordance with the present invention;

FIG. 2, in a flowchart, illustrates operations of the fund transfer method performed by a payment processing system part of the system of FIG. 1;

FIG. 3, in a schematic block diagram, illustrates a memory part of a mobile phone part of the system of FIG. 1;

FIG. 4, in a schematic block diagram, illustrates a memory part of the payment processing system of the system of FIG. 1;

FIG. 5, in a schematic block diagram, illustrates a memory part of a payor account server part of the system of FIG. 1;

FIG. 6, in a schematic block diagram, illustrates an account database stored in the memory of the payor account server;

FIG. 7, in a sequence diagram, illustrates the fund transfer method;

FIG. 8, in a schematic block diagram, illustrates an alternative embodiment of a memory part of the payment processing system of the system of FIG. 1;

FIG. 9, in a schematic block diagram, illustrates a user database stored in the memory of the payment processing system shown in FIG. 8;

FIG. 10, in a sequence diagram, illustrates part of an alternative fund transfer method; and

FIG. 11, in a flowchart, illustrates an authentication method usable in the present invention.

### DETAILED DESCRIPTION

The present invention relates to the transfer of funds between accounts. More specifically, the present invention aims, in some embodiments, at solving authentication and security problems that currently prevent individuals to spontaneously exchange money between themselves, in real time, without requiring complex registration processes, especially for the payee, and without having the funds transit through a stored value account or requiring that the payee performs operations on his computer or phone.

In a specific variant, the payor, who sends money, and the payee, who receive money, use their already issued debit cards for authentication and money routing purposes, and more specifically their debit card number. Advantageously, in some embodiments, the payee does not disclose his Personal Identification Number (PIN) that is used when the debit card is used to withdraw money at an Automated Teller Machine (ATM), or to make a purchase at a Point of Sale (POS) terminal. The payor uses his PIN to ensure that proper authorization is given to take money out of his account. In some embodiments, additional security measures are implemented to prevent unauthorized funds withdrawals. In the present document, it is understood that payor and payee may be the same individual, to allow for example transfer of funds between two accounts held by the payor in two different financial institutions.

The present invention does not require that the payee goes through the lengthy, complex and expensive process of becoming an authorized card accepter to be able to use the payee debit card number to transfer funds to the payee and allows the payor to send money to anyone who has a debit card, without requiring that the payee becomes a member of any web site or perform similar lengthy operations.

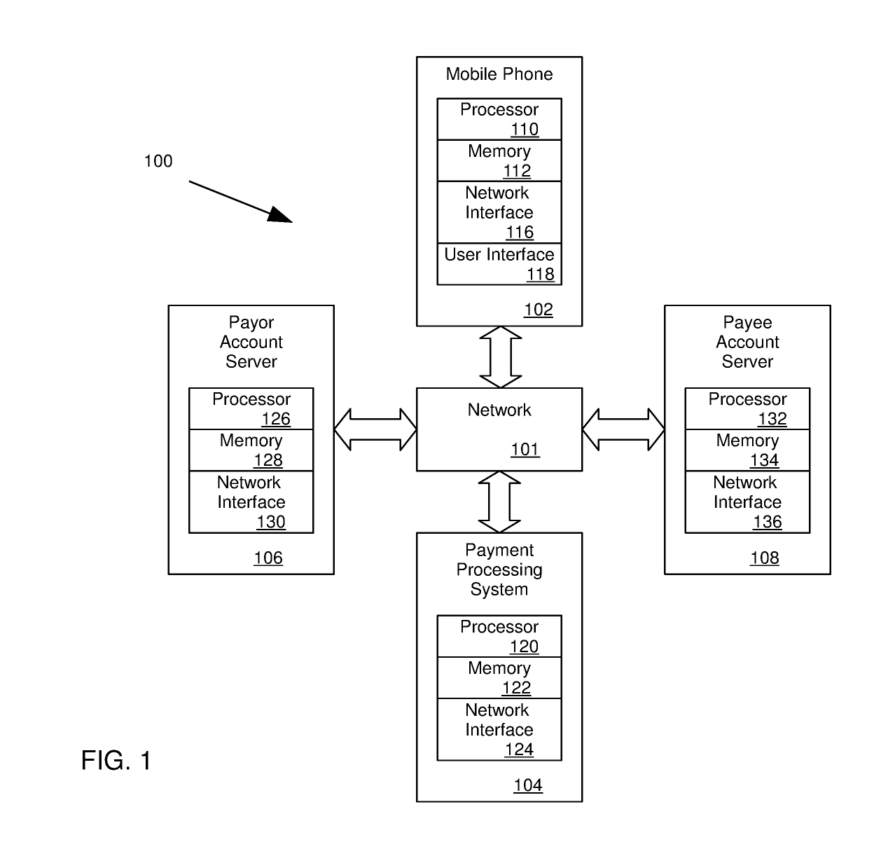

FIG. 1 represents elements of a system 100 in which the invention is implemented. The system 100 includes a mobile phone 102, a payment processing system 104, a payor account server 106 and a payee account server 108, all connected to a network 101. The network 101 is generally any mix of hardware and software that allows exchange of information between the components that are connected thereto. The network 101 may run different protocols over different portions thereof. Also, the network 101 includes any intermediary required to allow the mobile phone 102, payment processing system 104, payor account server 106 and payee account server 108 to communicate with each other, as would be the case in some countries in which a tree-like structure is in place to transfer funds between banks. However, in some embodiments, no intermediary is required. The network 101 may accept data from the mobile phone 102 either though a cell phone data connection, or through a WiFi connection. Typically, the payment processing system 104, payor account server 106 and payee account server 108 are wired to the network 101, but wireless communications between the network 101 and any of the payment processing system 104, payor account server 106 and payee account server 108 is also within the scope of the invention.

The payment processing system 104, payor account server 106 and payee account server 108 are computing devices or interlinked computing devices. While the payment processing system 104, payor account server 106 and payee account server 108 are represented as a single box, the functionality provided by these computing devices may be provided by a single computer each or by a multitude of computers each linked to each other, for example over a local area network (LAN).

It should be noted that the mobile phone 102 could be replaced in alternative embodiments by an other suitable device, such as another mobile device, for example a tablet, or by a computer.

Each of the mobile phone 102, payment processing system 104, payor account server 106 and payee account server 108 includes at least one processor 110, 120, 126 and 132, a memory 112, 122, 128 and 134 to store an operating system and software applications that the processor executes, as detailed hereinbelow, and a network interface 116, 124, 130 and 136 to provide a communication between the mobile phone 102, payment processing system 104, payor account server 106 or payee account server 108 and the network 101. As mentioned above, the network interface 116, 124, 130 and 136 may be different on different devices. For example, the network interface 116 of the mobile phone 102 may be coupled to an antenna for receiving and transmitting signals across the cellular network, or through a WiFi connection, while the network interface 124, 130 and 136 on the payment processing system 104, payor account server 106 and payee account server 108 may couple to a local network by an Ethernet cable. Any other means of connecting the mobile phone 102, payment processing system 104, payor account server 106 and payee account server 108 to the network 101 is also within the scope of the invention.

The mobile phone 102 also includes a user interface 118 allowing a payor and a payee to interact with the mobile phone 102. The user interface 118 may for example include a touch screen, but conventional screens coupled to a keyboard and/or a pointing device are also within the scope of the invention. In some embodiments, the payment processing system 104, payor account server 106 and payee account server 108 also include respective user interfaces for management and maintenance purposes, but implementation of the payment processing system 104, payor account server 106 and payee account server 108 on servers that do not have a user interface attached thereto, but instead communicate only through the network interface 130, are within the scope of the invention.

The memory 112, 122, 128 and 134 may include at least one of volatile memory, such as Random Access Memory, permanent memory, such as Read Only Memory, or rewritable non-volatile memory, such as Flash memory, and disc drives, optical drives or any other suitable mass storage devices, which are considered part of the memory 112, 122, 128 and 134 for the purpose of this document.

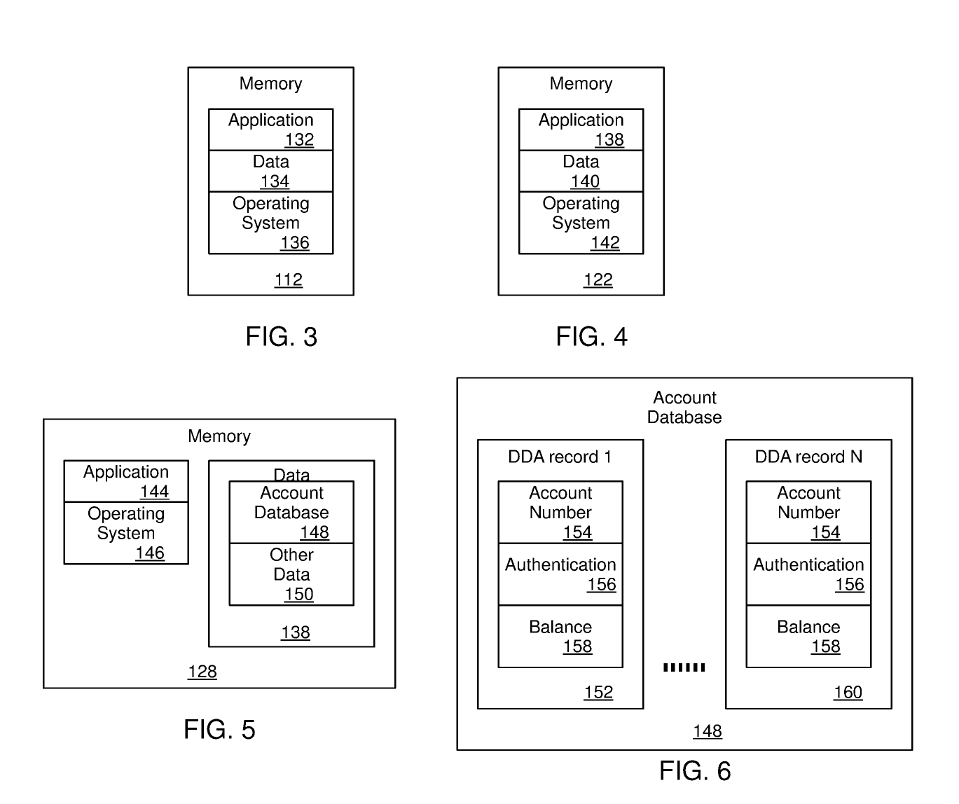

Referring to FIG. 3, the memory 112 contains an operating system 136, one or more applications 132 and data 134. The applications 132 and operating system 136 are executed by the processor 110. The data 134 is available to the operating system 136 and applications 132 for allowing them to perform their functions.

Referring to FIG. 4, the memory 122 contains an operating system 142, one or more applications 138 and data 140. The applications 138 and operating system 142 are executed by the processor 120. The data 140 is available to the operating system 142 and applications 138 for allowing the them to perform their functions.

Referring to FIG. 5, the memory 128 contains an operating system 146, one or more applications 144 and data 138. The applications 138 and operating system 142 are executed by the processor 120. The data 140 is available to the operating system 146 and applications 144 for allowing the them to perform their functions.

The data 138 includes an account database 148 and other data 150 required for operation of the payor account server 106. The account database 148 includes the information allowing the payor account server 106 to manage funds held by the payor at a financial institution operating the payor account server 106.

As illustrated in FIG. 6, the account database 128 includes a plurality of DDA records 152 or 160, only two of which are shown in FIG. 6. A typical financial institution has an account database 148 including up to millions of DDA records 152 and 160. One of the DDA records 152 or 160 corresponds to an account held by the payor.

Each DDA record 152 or 160 includes an account number 154 identifying uniquely an account in which there is an account balance represented by account balance information 158. Each DDA record also includes authentication information for confirming that an incoming request to affect the account balance is authorized by the owner of the account. For example, the authentication information 156 includes a debit card number to which the account identified by the account number 154 is associated, and a Personal Identification Number. Some operations on the DDA record 152 or 160, and more precisely some operations affecting the balance information 158, are only possible when the PIN and debit card number provided are matching. In some embodiments, the debit card number and PIN are encrypted, but they may also be stored without encryption. In some embodiments, some operations, typically credit operations that increase the balance 158, are allowed without requiring a PIN.

While a single account database 148 including all the DDA records 152 to 160 in what seems a sequential arrangements had been illustrated in FIG. 6, it should be understood that the account database 148 illustrated in FIG. 6 and that a an account database implementing the same functionality can be implemented in any suitable manner, for example through a relational database, or through many independent databases each including one or more of the account number 154, authentication information 156 and account balance information 158.

The payee account server 108 is similar to the payor account server 106 and is thus not described in further details herein. Indeed, identification of someone as being a payee or a payor does not affect the internal organization of the financial institutions where the payee and payor hold DDAs. Also, if the payor and payee have DDAs at the same financial institution, the payor and payee account servers 106 and 108 may be represented physically by the same server or bank of servers.

The disclosure may be described in the general context of computer-executable instructions, such as program modules referred to as applications and operating systems hereinabove, being executed by a computer or other similar device, such as the mobile phone 102. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

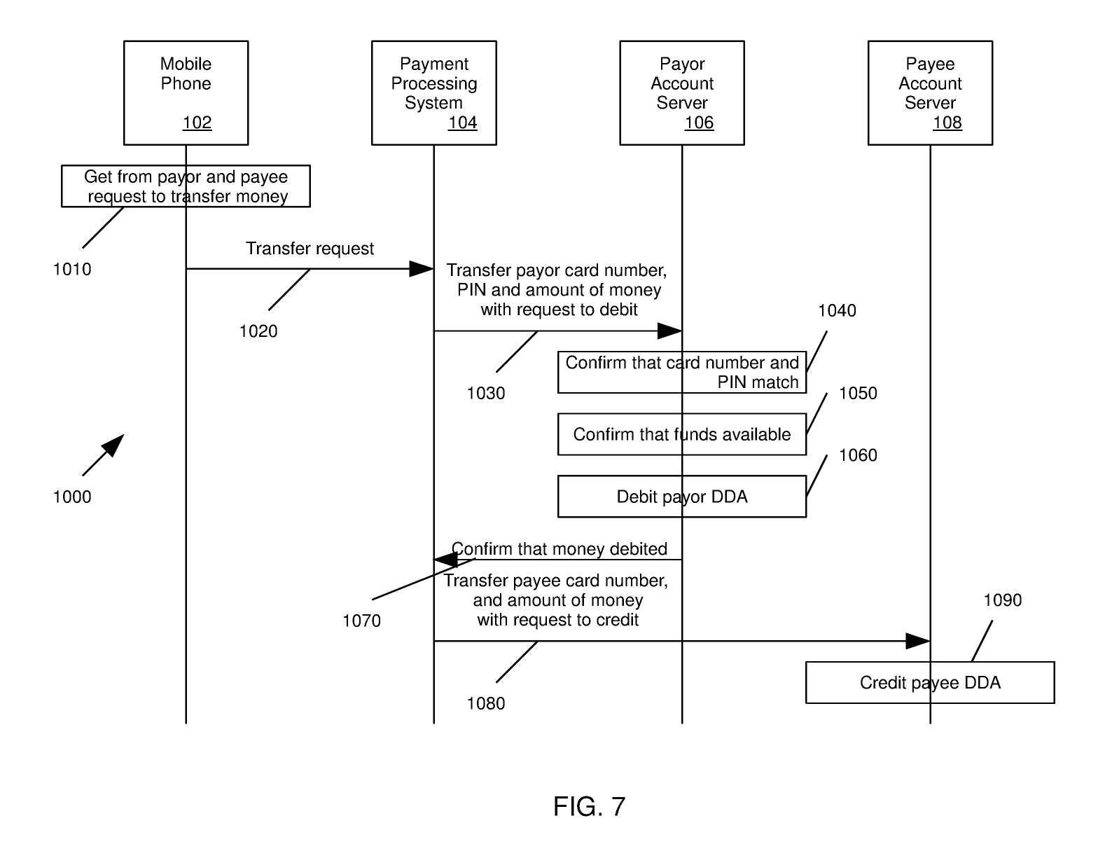

FIG. 7 is a sequence diagram 1000 illustrating an example of how funds can be transferred from the payor to the payee using the system 100 of FIG. 1 when the transfer is successful. As such, FIG. 7 does not illustrate the various manners in which the process can fail. It is assumed that if any of the steps shown in FIG. 7 fails, the amount of money will not be transferred, and that this error will be handled by the system 100 in conventional manners, for example by simply aborting the whole process, or allowing the payor and payee to try again.

First, at step 1010, a request to transfer an amount of money from the payor DDA to the payee DDA is entered by the payor and/or the payee on the mobile phone 102 using a payment application 132. The request includes transactions details. The transaction details include the amount of money, payor account information identifying the payor DDA and payee account information identifying the payee DDA. The payee account information includes a payee debit card number to which the payee DDA is associated, but typically excludes an account number identifying the payee DDA in the payee account database and excludes a payee personal identification number (PIN) associated with the payee debit card number. Thus, the payee account information is sufficient to identify the account in which the amount of money is to be transferred, but does not include enough information to withdraw money from the payee DDA should the payee information fall in the hands of a fraudster. The payor account information includes a payor debit card number to which the payee DDA is associated and a payor PIN associated with the payor debit card number, but typically excludes an account number identifying the payor DDA in the payor account database. The payor information must include enough information to withdraw money from the payor DDA. However, the risk of this information becoming available to a fraudster is small as the payor information is typically entered on the payor's own mobile phone 102.

Then, at step 1020, the payment application 132 transfers the request to the payment processing system 104 through the network 101. This request is then stored in the data 140 of the payment processing system 104 to be accessed by a processing application 138. The processing application 138 first authorizes the transfer by sending from the payment processing system 104 to the payor account server 106 through the network 101 the payor account information and the amount of money, along with a request to debit the amount of money. Identification of which account servers among a plurality of account servers connected to the network 101 is the payor account server 106 is for example made using the payor debit card number. Indeed, the first digits of any debit card uniquely identify the bank or other financial institution that issued the debit card.

The payor account server 106 receives the the request and, at step 1040, uses the payor debit card number to identify a DDA record, for example DDA record 152, in which the authentication information 156 includes the debit card number. Then, the payor account server 106 used the payor PIN contained in the authentication information 156 and compares it to the PIN contained in the request to confirm that access the the funds held in the DDA account associated with the DDA record 152 can be granted.

Subsequently, at step 1050, the payor account server 106 confirms that enough funds are available, for example by comparing the balance 158 found in the DDA record 152 to the amount of money. In some embodiments, if the balance 158 is larger than the amount of money, the funds are considered available.

Finally, if both steps 1040 and 1050 are successful, the payor DDA is debited from the amount of money at step 1060, and, at step 1070, the payor account server 106 sends to the payment processing system 104, through the network 101, a confirmation that the amount of money has been debited.

Once the confirmation has been received, the payment processing system 104 sends to the payee account server 108 through the network 101 the payee account information and the amount of money, along with a request to credit the amount of money.

Although not shown in the drawings, once the payee account server 108 has credited the payee DDA, the payee account server 108 may send a confirmation to the payment processing system 104, through the network 101, that the credit operation was successful, and the payment processing system 104 may send a confirmation to the payment application 132 running on the mobile phone 102, through the network 101, that the transfer was successful. While not compulsory, this confirmation is advantageous to confirm that the transfer was successful.

Confirmations received from the payor and payee account servers that respectively the payor DDA has been debited and that the payee DDA has been credited include in some embodiments an authorization code. This authorization code, along with the details of the transaction, are stored so that the payor and payee financial institutions can receive periodically a list of the transactions performed by the payment processing system 104 and reconcile these transactions between the two financial institutions in a conventional manner. Thus, the payor DDA account is immediately debited and the payee DDA account is immediately credited, but the actual money transfer is performed later. If for any reason the operations performed by the payment processing system 104 cannot be reconciled, charge backs can be applied to the transactions that contain errors.

In some embodiments, the service provider operating the payment processing system 104 may hold accounts at the payor and payee financial institutions so that the funds that are debited from the payor DDA are transferred to the service provider account at the payor financial institution, and the funds credited to the payee are debited from the service provider account at the payee financial institution, so that the service provider can operate the payment processing server 104 without requiring special infrastructure different from the infrastructure provided to merchants.

If any of steps 1030, 1040, 1050, 1060, 1070 or 1080 fails, the process stops and, in some embodiments, an error message, which may or may not include an indication of the type of error that occurred, is sent to the mobile phone 102 for display through the user interface 118.

It will be apparent from FIG. 7 that the whole process of transfer permits a payment from the payor DDA directly to the payee DDA without payment completion being conditional on use of a notify and pay instrument. In addition, the amount of money does not transact through a stored value account between the payor DDA and payee DDA as the payor's and payee's financial institution can then complete the actual money transaction using conventional Payment Acceptance. Also, in this embodiment, the payment system 100 only requires the transaction details provided on the a mobile phone 102 to transfer the amount of money from the payor DDA to the payee DDA. No pre-registration from the payee is required.

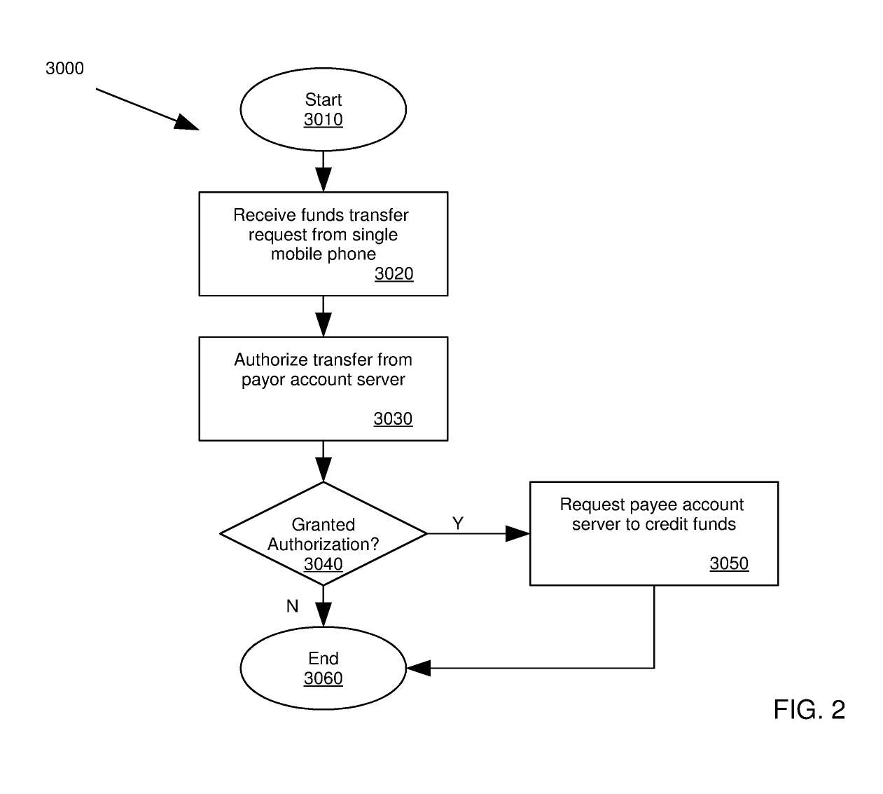

FIG. 2 illustrates in a flowchart the sequence of events related to the sequence diagram 1000 from the point of view of the payment processing system 104, thus implementing a fund transfer method 3000. The method 3000 starts at step 3010. Then, at step 3020, the request to transfer the amount of money is received from the mobile phone 102, corresponding to step 1020 in FIG. 7. Subsequently, at step 3030, the payment processing system 104 requests an authorization to debit the amount of money to the payor account server, corresponding to step 1030 in FIG. 7. Then, at step 3040, the payment processing system 104 then branches either to steps 3050, if the authorization has been granted, or to step 3060, if the authorization is not granted. At step 3050, the payment processing system 104 requests to the payee account server 108 to credit the amount of money to the payee DDA, corresponding to step 1080 in FIG. 7, and then jumps to step 3060, where the method ends.

Step 1010 may be performed in many ways. For example, at step 1010, the payor may enter using a keypad or a touch screen part of the user interface 118, his payor debit card number, his payor PIN, and the amount of money. Conveniently, in some embodiments, at least part of the payor debit card number and payor PIN are subsequently hidden. In some embodiments, the payor debit card number may be stored on the mobile phone 102 so that the payor does not have to enter it again. Then, the payee may enter his payee debit card number in the same manner, which may then be also at least in part hidden after confirmation that the payee debit card number has been rightly entered. The payment application 118 may then proceed automatically to the transfer of funds, or request a confirmation that the transfer can proceed before doing so.

It is advantageous in some embodiments to replace at least some of the manual entries made by the payor or payee by more automated processed. Notably, instead of receiving manually entered payee and/or payor debit card numbers, the payment application 118 may use the cell phone camera to take a picture of the corresponding debit cards and extract the relevant numbers automatically using known character recognition algorithms. In yet other embodiments, the payor and/or the payee debit card numbers are acquired by scanning the magnetic strip of the payor and/or payee debit card, ‘waving’ a contactless smart card or scanning the face of a debit or of a credit card associated with the account of payee on which the payee card number is shown or inputting the MICR encoding of a cheque associated with an account of the payee.

Steps 1040, 1050 and 1060 proceed conventionally, for example in the manner similar to the manner in which a buyer's account is debited when the buyer uses a debit card to pay in a store. It should be noted that at step 1050, the condition for the availability of funds is not necessarily that the balance 158 of the payor's DDA is larger than the amount of money to transfer. In some embodiments, an overdraft may be allowed on the account, either by a predetermined amount provided by an overdraft protection, or through a courtesy overdraft allowing the payor to go slightly into debt so that the transfer can occur.

At step 1070, the payor account server 106 sends to the payment processing system 104 data indicating that the debit operation has been authorized. The data may include a token indicative of acceptance of the debit operation, such as data including a predetermined value, either numerical or alphanumerical. In some embodiments, the data may also include an authorization code, which is a numerical or alphanumerical value associated with the debit transaction.

In some embodiments, the transaction details further include a payee account tag identifying the payee DDA from other possible DDAs associated with the payee debit card. Indeed, it is common to have a debit card associated with two or more accounts, and selection of which of these accounts is used to perform the transfer is made using the payee account tag. Selection of the payee account tag is made at step 1010 and the payee account tag is then used by the payee account server 108 to select the right DDA record 152 corresponding to the payee debit card number and to the account tag. In this case, each DDA record 152 or 160 may include balance information 158 for more than one account and more than one account number 154, one for each of the possible payee account tags. In other embodiments, each DDA record 152 and 160 corresponds to only one account, but two or more of the DDA records 152 and 160 include the same payee debit card number in the authentication information 156, these DDA records 152 and 160 being differentiated by the inclusion, for example in the authentication information 156, of the corresponding payee account tag. For example, the payee account tag identifies one of a savings account and a chequing account. Similarly, a payor account tag having the same function as the payee account tag can be used in the same manner as will be recognized by the person skilled in the art.

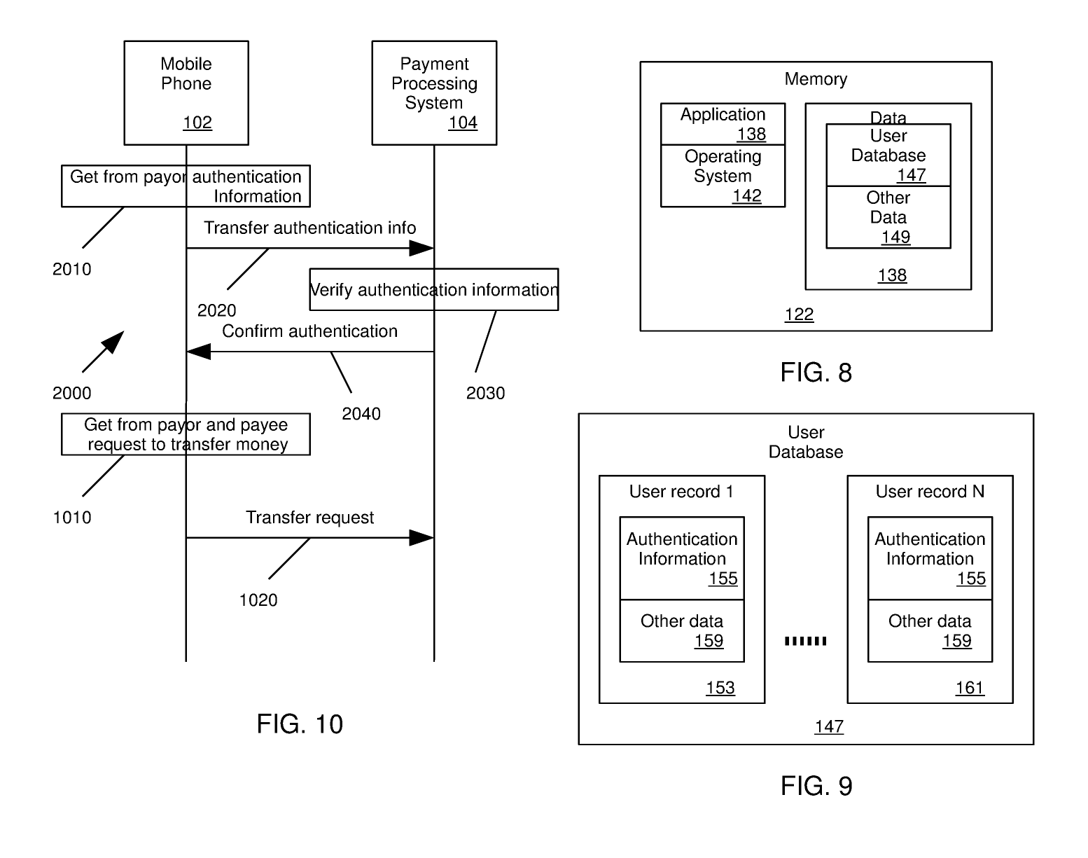

In some embodiments, the above-mentioned transfer information is the only information required from the mobile phone 102 to perform the transfer. However, in alternative embodiments, the payor holds a user account on the payment processing system 104 to increase security. In that case, the payment processing system 104 includes a user database 147 and other data 149 in its data 140, as seen in FIG. 8. The user database 147 includes user records 153 and 161, each including user information. As with the account database 148, the user database 147 is illustrated as having the specific structure shown in the drawings for illustrative purposes and alternative structures are within the scope of the invention. Also, the number of user records 153 and 161 is typically relatively large. One of the user records 153 or 161 includes user information associated with the payor. The user information includes user authentication information 155 for authenticating the payor, and other data 159, such as a mailing address of the payor, one or more email addresses associated with the payor, billing information for billing the payor and other useful information.

FIG. 10 is a sequence diagram 2000 illustrating an alternative embodiment of the invention where the payor is authenticated before being authorized to perform the transfer of money. To that effect, at step 2010, the payor enters attempted authentication information in the payment application 132 using the user interface 118. The mobile phone 102 then transfers the authentication information to the payment processing system 104 through the network 101 at step 2020 and the payment processing system verifies the authentication information at step 2030. If the authentication information is verified, for example if the attempted authentication information matches the user authentication information 155 of one of the user records 153 and 161, the payment processing system 104 confirms to the payment application 118 at step 2040 that financial transactions can proceed by sending a suitable message through the network 101 to the mobile phone 102. Once the payor is authenticated, the remainder of the process illustrated in the sequence diagram 1000 of FIG. 7 can proceed, as partially illustrated in FIG. 10. If authentication fails, that is if the authentication is not confirmed at step 2040, the payment application does not proceed to step 1010 or to step 1020 and, for example, the payor may attempt another authentication by looping back to step 2010 (not shown in the drawings). It should be noted that in alternative embodiments, authentication may occur at any other suitable time, for example simultaneously with the request to transfer money.

Authentication can proceed in many different manners. In one example, the user authentication information 155 includes a user name and a password. The user name may be, for example, any suitable alphanumeric string. In some embodiments, the user name is the payor debit card number. In yet other embodiments, the user name is an email address associated with the payor. The password may be, for example, any word or string of characters that may be anticipated by individual to be secret and unique. In this example, the attempted authentication information includes an attempted name and attempted password and authentication proceeds by comparing the user name and the attempted name to each other comparing the user password and the attempted password to each other and causing the transfer of the amount of money only if the user name and the attempted name are identical and if the user password and the attempted password are identical.

In other examples, the user authentication information includes a user phone number and the attempted authentication information includes a single mobile phone number associated with the single mobile phone. This single mobile phone number may for example be read from the operating system 136 of the single mobile phone or entered manually by the payor. Then, authentication proceeds by comparing the single mobile phone number and the user phone number and causing the transfer of the amount of money only if the single mobile phone number and the user phone number are identical. This manner of proceeding ensures that money can be transferred from the payor DDA only from one single device owned by the payor.

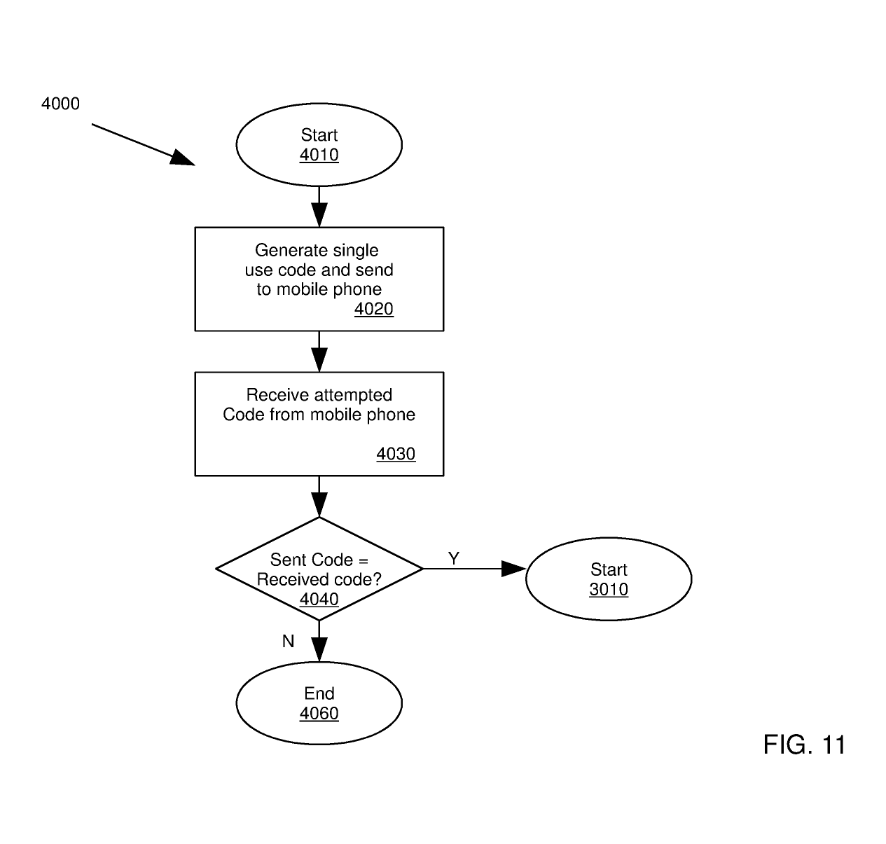

In yet another example, the user authentication information also includes the user phone number. In such embodiments, the method 3000 is preceded by the method 4000 of FIG. 11, which starts at step 4010 and proceeds to step 4020. At step 4020, the payment processing system 104 generates a single use code and sends the single use code via text message to the user mobile phone 102 using the user phone number. This single use code can be any chain of characters, including a numerical chain of characters that is generated and changed each time a new authentication is desired. The text message including the single use code is received by the single mobile phone 102 and entered by the payor or payee using the user interface 118, or automatically captured by the payment application 132 as the text message arrives, after which the payment application 132 sends the single use code back to the payment processor 104 through the network 101. Then, the method 4000 proceeds to step 4030 where the payment processor 104 receives from the single mobile device the attempted code entered by the payor or the payee, and causes the transfer of money to proceed only if the attempted code and single use code are identical. For example, if the attempted code and the single use code are identical, at step 4040, the method 4000 proceeds to step 3010 of method 3000, but if the attempted code and the single use code are not identical, the method 4000 ends at step 4050.

The use of the single use code ensures that only someone in physical possession of the single mobile phone associated with the user phone number can proceed with the transfer of the amount of money.

It should be noted that one or more of the above described authentication examples may be combined to provide a more secure system 100. Also, in some embodiments, authentication is only required for certain predetermined transactions. For example, if the payor never transacted with a certain payee, authentication may be required on the first transaction performed with this payee. In another example, authentication is required only if the amount of money is larger than a predetermined amount, or if the sum of the amounts of money of many transactions performed within a predetermined duration, for example a day, an hour or a week, is larger than a predetermined amount.

In some variants, the payor debit card number is not entered by the payor each time the payment application 132 is used. Instead, the payor debit card number is stored in the memory 112 of the mobile phone 102 after having been entered once, or otherwise transmitted to the payment application 132, and then retrieved from the memory 112 each time the payment application 118 is run. In these variants, it is advantageous to use authentication as this greatly increases security, compared to use of the payor PIN.

In some embodiments, the payment processing system 104 may also be, for example, configured to charge a fee for the fund transfer service, which fee may be, for example, instantiated in addition to the amount to transfer or netted from the amount of the payment made by payor. In either instance, payment processing system 104 may be configured to route the fee as charged to an account owned the entity or entities performing the fund transfer service through the payment processing system 104.

While the invention, the illustrative systems and the methods as described herein by way of example and teachings embodying various aspects of the present disclosure, it will be understood that the invention is not limited to these embodiments. Modifications may be made by those skilled in the art and may be made without departing from the true spirit and scope of the present disclosure. For example, each of the elements of the aforementioned embodiments may be utilized alone or in combination or sub-combination with elements of the other embodiments. Therefore, the description is not to be regarded as restrictive on the present invention and accordingly the claims below should be accorded the broadest interpretations so as to encompass all such modifications and similar arrangements.

1. A computer implemented method, executed by a payment processing system for causing transfer of an amount of money from a payor demand deposit account (DDA) owned by a payor to a payee DDA owned by a payee, at least one of the payor and payee using a single mobile phone in communication with the payment processing system to provide transaction details specifying the amount of money and identifying the payor DDA and payee DDA, the payment processing system being in communication with a payee account server and a payor account server, the payee and payor account servers including respectively a payee bank account database and a payor bank account database, the payee and payor bank account databases including respectively payee and payor DDA records containing each account number, authentication information and account balance information related respectively to the payee and payor DDAs, the method computer implemented method comprising:
receiving at the payment processing system, from a payment application running on the single mobile phone, a request to transfer the amount of money from the payor DDA to the payee DDA, the request including transactions details, the transaction details including the amount of money, payor account information identifying the payor DDA and payee account information identifying the payee DDA, wherein the payee account information includes a payee debit card number to which the payee DDA is associated, excludes an account number identifying the payee DDA in the payee account database and excludes a payee personal identification number (PIN) associated with the payee debit card number, and wherein the payor account information includes a payor debit card number to which the payee DDA is associated and a payor PIN associated with the payor debit card number, and excludes an account number identifying the payor DDA in the payor account database;
upon receiving the request, authorizing the transfer by sending from the payment processing system to the payor account server the payor account information and the amount of money and receiving from the payor account server a confirmation that the account database includes the payor account corresponding to the payor debit card number and payor PIN and that the amount of money is debited from the payor DDA;
upon receiving the confirmation, requesting from the payment processing system to the payee account server that the payee account be credited by sending to the payee account server the payee account information, the amount of money and a request to credit the payee DDA;
wherein the method permits a payment from the payor DDA directly to the payee DDA without payment completion being conditional on use of a notify and pay instrument.

2. The method as defined in claim 1, wherein the payment system only requires the transaction details provided on the single mobile phone to transfer the amount of money from the payor DDA to the payee DDA.

3. The method as defined in claim 1, wherein the amount of money does not transact through a stored value account between the payor DDA and payee DDA.

4. The method as defined in claim 1, wherein the payor DDA and the payee DDA are held in different financial institutions.

5. The method as defined in claim 1, wherein the transaction details further include a payee email address, the method further comprising sending to the payee email address a transaction summary email including information representative of the payee DDA and of the amount of money after the amount of money has been credited in the payee DDA.

6. The method as defined in claim 1, wherein the transaction details further include a payee account tag identifying the payee DDA from other possible DDAs associated with the payee debit card.

7. The method as defined in claim 6, wherein the payee account tag identifies one of a savings account and a chequing account.

8. The method as defined in claim 1, wherein the method permits that the amount of money be transferred from the payor DDA to the payee DDA in real-time and at any time and from anywhere.

9. The method as defined in claim 1, wherein the payee debit card number has been obtained by taking a picture of the payee debit card on the single mobile device and automatically extracting the payee debit card number from the picture.

10. The method as defined in claim 1, wherein a user database is stored at the payment processing system, the user database including user information associated with the payor, the user information including user authentication information for authentication the payor, the method further comprising receiving from the single mobile phone attempted authentication information and causing the transfer of the amount of money only if the user authentication information matches the attempted authentication information.

11. The method as defined in claim 10, wherein the user authentication information includes a user phone number and the attempted authentication information includes a single mobile phone number associated with the single mobile phone, the method further comprising comparing the single mobile phone number and the user phone number and causing the transfer of the amount of money only if the single mobile phone number and the user phone number are identical.

12. The method as defined in claim 10, wherein the user authentication information includes a user name and user password and the attempted authentication information includes an attempted name and attempted password, the method further comprising comparing the user name and the attempted name to each other and comparing the user password and the attempted password to each other and causing the transfer of the amount of money only if the user name and the attempted name are identical and if the user password and the attempted password are identical.

13. The method as defined in claim 10, wherein the user authentication information also includes a user phone number, the method further comprising
generating at the payment processing system a single use code and sending the single use code via text message to the user phone number; and
receiving from the single mobile device an attempted code entered by the payor or the payee, causing the transfer of money proceeding only if the attempted code and single use code are identical.

14. The method as defined in claim 1, wherein authorizing the transfer also includes sending from the payment processing system a service charge added to the amount of money and receiving from the payor account server confirmation the that the service charge has also been debited from the from the payor DDA.

15. A method, executed by a payment processing system for causing transfer of an amount of money from a payor demand deposit account (DDA) owned by a payor to a payee DDA owned by a payee, at least one of the payor and payee using a single mobile phone in communication with the payment processing system to provide transaction details specifying the amount of money and identifying the payor DDA and payee DDA, the payment processing system being in communication with a payee account server and a payor account server, the payee and payor account servers including respectively a payee bank account database and a payor bank account database, the payee and payor bank account databases including respectively payee and payor DDA records containing each account number, authentication information and account balance information related respectively to the payee and payor DDAs, the method computer implemented method comprising:
receiving in a payment application running on the single mobile phone transaction details through a user interface of the single mobile phone, the transaction details including the amount of money, payor account information identifying the payor DDA and payee account information identifying the payee DDA, wherein the payee account information includes a payee debit card number to which the payee DDA is associated, excludes an account number identifying the payee DDA in the payee account database and excludes a payee personal identification number (PIN) associated with the payee debit card number, and wherein the payor account information includes a payor debit card number to which the payee DDA is associated and a payor PIN associated with the payor debit card number, and excludes an account number identifying the payor DDA in the payor account database;
sending from the single mobile phone to the payment processing system a request to transfer the amount of money from the payor DDA to the payee DDA, the request including the transactions details;
receiving the request to transfer the amount of money at the payment processing system;
upon receiving the request to transfer the amount of money, sending from the payment processing system to the payor account server the payor account information and the amount of money, along with a request to debit the amount of money from the payor DDA;
receiving at the payor account server the payor account information, the amount of money, and the request to debit the amount of money from the payor DDA;
confirming at the payor account server that the payor PIN and payor debit card number match data stored in an account database;
debiting the amount of money from the payor DDA at the payor account server;
sending from the payor account server to the payment processing system a confirmation that the account database includes the payor account corresponding to the payor debit card number and payor PIN and that the amount of money is debited from the payor DDA;
upon receiving the confirmation at the payment processing system, sending from the payment processing system to the payee account server a request that the payee DDA be credited by sending to the payee account server the payee account information, the amount of money and a request to credit the payee DDA;
receiving at the payee account server the payee account information, the amount of money and the request to credit the payee DDA; and
crediting the amount of money from the payee DDA at the payor account server;
wherein the method permits a payment from the payor DDA directly to the payee DDA without payment completion being conditional on use of a notify and pay instrument.

16. The method as defined in claim 15, further comprising
sending from the payee account server to the payment processing system a confirmation that the amount of money is credited to the payor DDA;
receiving at the payor account server the confirmation that the amount of money is credited to the payor DDA;
sending from the payor account server to the single mobile phone a confirmation that the transfer has been completed; and
displaying on the user interface an indication that the transfer has been completed.

17. A transaction system for causing transfer of an amount of money from a payor demand deposit account (DDA) owned by a payor to a payee DDA owned by a payee, the transaction system comprising:
a mobile phone running a payment application operative to provide transaction details specifying the amount of money and identifying both the payor DDA and payee DDA;
a payee account server and a payor account server, the payee and payor account servers including respectively a payee bank account database and a payor bank account database, the payee and payor bank account databases including respectively payee and payor DDA records containing each account number, authentication information and account balance information related respectively to the payee and payor DDAs, the payee and payor account servers;
a payment processing system in communication with the mobile phone, the payee account server and the payor account server, the payment processing system being operative for:
receiving from the payment application running on the mobile phone a request to transfer the amount of money from the payor DDA to the payee DDA, the request including transactions details, the transaction details including the amount of money, payor account information identifying the payor DDA and payee account information identifying the payee DDA, wherein the payee account information includes a payee debit card number to which the payee DDA is associated, excludes an account number identifying the payee DDA in the payee account database and excludes a payee personal identification number (PIN) associated with the payee debit card number, and wherein the payor account information includes a payor debit card number to which the payee DDA is associated and a payor PIN associated with the payor debit card number, and excludes an account number identifying the payor DDA in the payor account database;
upon receiving the request, authorizing the transfer by sending to the payor account server the payor account information and the amount of money and receiving from the payor account server a confirmation that the account database includes the payor account corresponding to the payor debit card number and payor PIN and that the amount of money is debited from the payor DDA;
upon receiving the confirmation, requesting to the payee account server that the payee account be credited by sending to the payee account server the payee account information, the amount of money and a request to credit the payee DDA;
wherein the payment from the payor DDA directly to the payee DDA is performed without payment completion being conditional on use of a notify and pay instrument.

18. The transaction system as defined in claim 17, wherein the payor DDA and the payee DDA are held in different financial institutions.

19. The method as defined in claim 17, wherein the mobile phone includes a camera, the payment application being operative for using the camera to take a picture of the payee debit card and for automatically extracting the payee debit card number from the picture.
